(19) United States
(12) Patent Application Publication
(10) Pub. No.: US 2022/0328887 A1
(43) Pub. Date: Oct. 13, 2022

(54) BATTERY AND ELECTRONIC DEVICE INCLUDING SAME

(71) Applicant: SAMSUNG ELECTRONICS CO., LTD., Suwon-si, Gyeonggi-do (KR)

(72) Inventors: Kiyoun JANG, Suwon-si, Gyeonggi-do (KR); Myeongho KIM, Suwon-si, Gyeonggi-do (KR); Shihyun KIM, Suwon-si, Gyeonggi-do (KR); Jongho JUN, Suwon-si, Gyeonggi-do (KR); Sangcheul LEE, Suwon-si, Gyeonggi-do (KR)

(21) Appl. No.: 17/434,984

(22) PCT Filed: Aug. 23, 2021
(86) PCT No.: PCT/KR2021/011198

§ 371 Date: Aug. 30, 2021

(30) Foreign Application Priority Data
Sep. 1, 2020 (KR) 10-2020-0110839

(51) Int. Cl. H01M 10/42; H01M 50/204; H01M 50/59; H02J 7/00

(52) U.S. Cl. CPC H01M 10/425; H01M 50/204; H01M 50/59; H02J 7/0029; H01M 2220/30

(57) ABSTRACT

According to various embodiments disclosed herein, a battery and/or an electronic device including the same may include: a battery cell; and a circuit board assembly including a charge protective circuit, the circuit board assembly being disposed on one side of the battery cell, wherein the circuit board assembly may include a first side surface disposed in a longitudinal direction or a width direction to face the battery cell, at least one first part having a first thickness in a thickness direction perpendicular to the longitudinal direction or the width direction, and at least one second part having a second thickness greater than the first thickness, and a portion of the second part may provide a dispersion area including at least a portion of the first side surface.

### CROSS-REFERENCE TO RELATED APPLICATIONS

This application is a national stage of International Application No. PCT/KR2021/011198 designating the United States, filed on Aug. 23, 2021, in the Korean Intellectual Property Receiving Office and claiming priority to Korean Patent Application No. 10-2020-0110839, filed on Sep. 1, 2020, in the Korean Intellectual Property Office, the disclosures of which are incorporated by reference herein in their entireties.

### BACKGROUND

### Field

The disclosure relates to an electronic device. For example, various embodiments relate to a battery and/or an electronic device including the same.

### Description of Related Art

As electronic, information, and communication technologies have developed, various functions have come to be integrated into a single electronic device. For example, a smartphone includes functions of an audio reproduction device, an imaging device, or a digital diary, in addition to a communication function, and a greater variety of functions may be implemented in the smartphone through installation of additional applications. An electronic device may be provided with various pieces of information in real time by accessing a server or another electronic device in a wired or wireless manner as well as by executing an installed application or a stored file.

As it has become common for users to carry and use electronic devices, the electronic devices may be exposed to the risk of damage due to external impacts such as being dropped. Damage due to external impacts may include not only damage to the exterior of an electronic device, but also damage to an internal electric/electronic component. A manufacturer may prevent damage due to such external impacts and improve reliability of an electronic device through a material or a structural design of the electronic device. For example, a manufacturer may reduce the possibility of breakage through a material that is not easily damaged even with external impacts or a structural design that disperses the impact to other parts when an impact is applied.

Since conditions such as magnitudes and directions of impacts applied to an electronic device vary considerably, there may be a limitation in designing or combining structures capable of dispersing external impacts. Various electric/electronic components, such as a circuit board, an integrated circuit chip or a passive/active element mounted on the circuit board, a sound device (e.g., a microphone or a speaker), various sensor devices, and/or a battery, may be disposed inside an electronic device. These electric/electronic components may be partially replaceable or repairable depending on damage due to an impact or on durability life. For example, a structure or an electric/electronic component damaged by an external impact may be generally replaceable or repairable. However, when a battery is damaged by an external impact, the battery may swell, burn, or explode. When substances inside the battery, such as electrolyte, leak before combustion or explosion, the substances may contaminate the space inside the electronic device or damage other electric/electronic components.

### SUMMARY

Embodiments of the disclosure provide a battery with improved reliability against an external shock and/or an electronic device including the same.

Embodiments of the disclosure provide a structure capable of dispersing or alleviating an impact applied to a battery or battery cell and/or an electronic device including the same.

Embodiments of the disclosure provide a structure for preventing and/or reducing damage to a battery by dispersing or alleviating an impact and/or an electronic device including the same.

According to various example embodiments of the disclosure, a battery and/or an electronic device including the same may include: a battery cell; and a circuit board assembly including a charge protective circuit, the circuit board assembly being disposed on one side of the battery cell, wherein the circuit board assembly may include a first side surface disposed in a longitudinal direction or a width direction facing the battery cell, at least one first part having a first thickness in a thickness direction perpendicular to the longitudinal direction or the width direction, and at least one second part having a second thickness greater than the first thickness, and a portion of the second part may provide a first dispersion area including at least a portion of the first side surface.

According to various example embodiments of the disclosure, an electronic device may include: a housing; a support disposed in the housing; and a battery at least partially seated on one surface of the support in the housing, wherein the battery may include: a battery cell; and a circuit board assembly including a charge protective circuit, the circuit board assembly being disposed on one side of the battery cell, wherein the circuit board assembly may include a first side surface disposed in a longitudinal direction or a width direction facing the battery cell, at least one first part having a first thickness in a thickness direction perpendicular to the longitudinal direction or the width direction, and at least one second part having a second thickness greater than the first thickness, and a portion of the second part providing a dispersion area including at least a portion of the first side surface.

According to various example embodiments, it is possible for a circuit board assembly disposed adjacent to a battery cell in a battery to have a larger area than a general printed circuit board on a surface facing the battery cell (e.g., the first side surface to be described in greater detail below). For example, when an impact is transferred to the battery cell through the circuit board assembly, the impact force can be dispersed over a larger area. By dispersing the impact applied to the battery cell over a larger area, it is possible to alleviate or prevent damage to the battery and/or the battery cell, and to improve the reliability of the battery against an external shock.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a front perspective view illustrating an electronic device according to various embodiments;

FIG. 2 is a rear perspective view illustrating the electronic device according to various embodiments;

FIG. 3 is an exploded perspective view illustrating the electronic device illustrated in FIG. 1 according to various embodiments;

FIG. 4 is a cross-sectional view illustrating an example configuration of the electronic device with the battery disposed therein according to various embodiments;

FIG. 5 is an enlarged view of a portion of a battery of the electronic device according to various embodiments;

FIG. 6 is an enlarged view of another portion of the battery of the electronic device according to various embodiments;

FIG. 7 is a perspective view illustrating a top surface of a circuit board assembly in the battery of the electronic device according to various embodiments;

FIG. 8 is a perspective view illustrating a bottom surface of the circuit board assembly in the battery of the electronic device according to various embodiments;

FIG. 9 is a plan view illustrating an upper surface of the circuit board assembly in the battery of the electronic device according to various embodiments;

FIG. 10 is a plan view illustrating the circuit board assembly in the battery of the electronic device with the reinforcing member(s) removed from the circuit board assembly according to various embodiments;

FIG. 11 is a diagram illustrating a first side surface of the circuit board assembly in the battery of the electronic device according to various embodiments;

FIG. 12 is a diagram illustrating a second side surface of the circuit board assembly in the battery of the electronic device according to various embodiments;

FIG. 13 is a cross-sectional of the circuit board assembly in the battery of the electronic device according to various embodiments; and

FIG. 14 is a bottom view illustrating an example modification of the circuit board assembly in the battery of the electronic device according to various embodiments.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

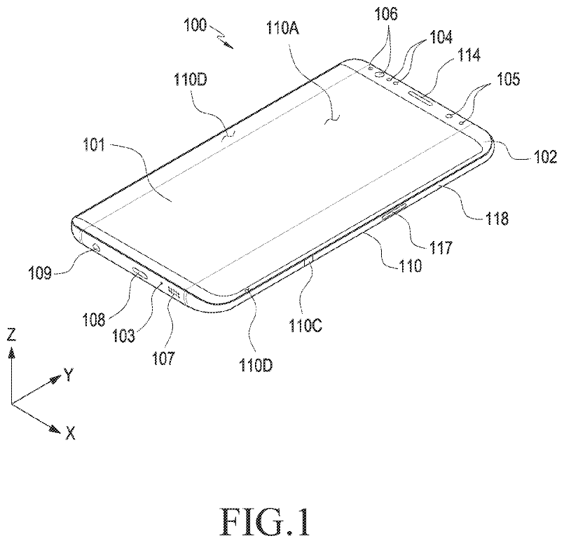

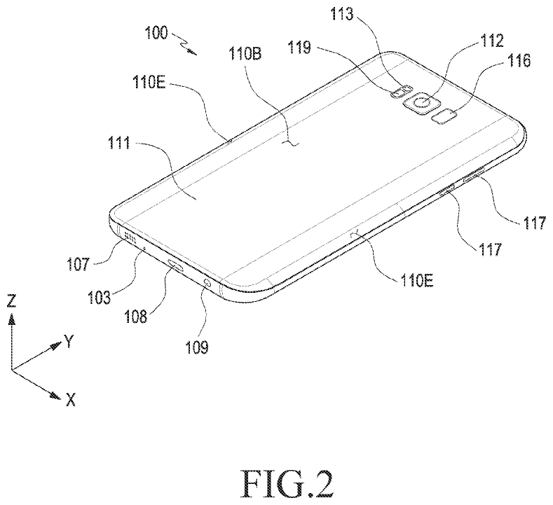

FIG. 1 is a front perspective view illustrating an electronic device 100 according to various embodiments. FIG. 2 is a rear perspective view illustrating the electronic device 100 according to various embodiments.

Referring to FIGS. 1 and 2, the electronic device 100 according to an embodiment may include a housing 100 including a first surface (or a front surface) 110A, a second surface (or a rear surface) 110B, and a side surface 110C surrounding the space between the first surface 110A and the second surface 110B. In an embodiment (not illustrated), the term “housing” may refer, for example, to a structure defining some of the first surface 110A, the second surface 110B, and the side surface 110C of FIG. 1. According to an embodiment, at least a portion of the first surface 110A may be defined by a substantially transparent front plate 102 (e.g., a glass plate or a polymer plate including various coating layers). The second surface 110B may be defined by a substantially opaque rear plate 111. The rear plate 111 may be made of, for example, coated or colored glass, ceramic, a polymer, a metal (e.g., aluminum, stainless steel (STS), or magnesium), or a combination of two or more of these materials. The side surface 110C may be defined by a side bezel structure 118 (or a “side member”) coupled to the front plate 102 and the rear plate 111 and including a metal and/or a polymer. In various embodiments, the rear plate 111 and the side bezel structure 118 may be integrally configured, and may include the same material (e.g., a metal material such as aluminum).

In the illustrated embodiment, the front plate 102 may include two first regions 110D, which are bent from the first surface 110A toward the rear plate 111 and extend seamlessly, at the long opposite side edges thereof. In the illustrated embodiment (see FIG. 2), the rear plate 111 may include two second regions 110E, which are bent from the second surface 110B toward the front plate 102 and extend seamlessly, at the long opposite side edges thereof. In various embodiments, the front plate 102 (or the rear plate 111) may include only one of the first regions 110D (or the second regions 110E). In an embodiment, some of the first regions 110D or the second regions 110E may not be included. In the embodiments described above, when viewed from the side of the electronic device 100, the side bezel structure 118 may have a first thickness (or width) on the side surface portions that do not include the first regions 110D or the second regions 110E described above, and may have a second thickness, which is smaller than the first thickness, on the side surface portions that include the first regions 110D or the second regions 110E.

According to an embodiment, the electronic device 100 may include at least one of a display 101, audio modules 103, 107, and 114, sensor modules 104, 116, and 119, camera modules 105, 112, and 113, key input devices 117, light-emitting elements 106, and connector holes 108 and 109. In various embodiments, in the electronic device 100, at least one of the components (e.g., the key input devices 117 or the light-emitting elements 116) may be omitted, or other components may be additionally included.

The display 101 may be exposed through, for example, a considerable portion of the front plate 102. In various embodiments, at least a portion of the display 101 may be visible through the front plate 102 defining the first surface 110A and the first regions 110D of the side surfaces 110C. In various embodiments, the edges of the display 101 may be configured to be substantially the same as the shape of the periphery of the front plate 102 adjacent thereto. In an embodiment (not illustrated), the distance between the periphery of the display 101 and the periphery of the front plate 102 may be substantially constant in order to enlarge the exposed area of the display 101.

In an embodiment (not illustrated), recesses or openings may be provided in a portion of a screen display region of the display 101, and at least one of an audio module 114, a sensor module 104, a camera module 105, and a light-emitting element 106, which are aligned with the recesses or the openings, may be included. The recesses or the openings may be notch areas extending inward of the display 101 or transparent areas substantially surrounded by the screen display area of the display 101. For example, substantially the entire area of the front plate 102 may be set as the screen display area of the display 101, and the sensor modules 104 (e.g., a proximity sensor or an illuminance sensor) or the camera modules 105 may acquire visual information (e.g., lighting brightness or subject image) through the recesses or the openings.

In an embodiment (not illustrated), the rear surface of the screen display area of the display 101 may include at least one of the audio modules 114, the sensor modules 104, the camera modules 105, the fingerprint sensor 116, and the light-emitting elements 106. In an embodiment (not illustrated), the display 101 may be coupled to or disposed adjacent to a touch-sensitive circuit, a pressure sensor capable of measuring a touch intensity (pressure), and/or a digitizer configured to detect a magnetic-field-type stylus pen. In various embodiments, at least some of the sensor modules 104 and 119 and/or at least some of the key input devices 117 may be disposed in the first regions 110D and/or the second regions 110E.

The audio modules 103, 107, and 114 may include a microphone hole 103 and speaker holes 107 and 114. The microphone hole 103 may include a microphone disposed therein to acquire external sound, and in various embodiments, multiple microphones may be disposed therein to be able to detect the direction of sound. The speaker holes 107 and 114 may include an external speaker hole 107 and a phone call receiver hole 114. In various embodiments, the speaker holes 107 and 114 and the microphone hole 103 may be implemented as a single hole, or a speaker may be included without the speaker holes 107 and 114 (e.g., a piezo speaker).

The sensor modules 104, 116, and 119 may generate electrical signals or data values corresponding to the internal operating state or the external environmental state of the electronic device 100. The sensor modules 104,116, and 119 may include, for example, a first sensor module 104 (e.g., a proximity sensor) and/or a second sensor module (not illustrated) (e.g., a fingerprint sensor) disposed on the first surface 110A of the housing 110, and/or a third sensor module 119 (e.g., an HRM sensor) and/or a fourth sensor module 116 (e.g., a fingerprint sensor) disposed on the second surface 110B of the housing 110. The fingerprint sensor may be disposed not only on the first surface 110A (e.g., the display 101) of the housing 110, but also on the second surface 110B. The electronic device 100 may further include at least one of sensor modules (not illustrated), such as a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

The camera modules 105, 112, and 113 may include a first camera device 105 disposed on the first surface 110A of the electronic device 100, a second camera device 112 disposed on the second surface 110B thereof, and/or a flash 113. The camera devices 105 and 112 may include one or more lenses, an image sensor, and/or an image signal processor. The flash 113 may include, for example, a light-emitting diode or a xenon lamp. In various embodiments, two or more lenses (e.g., an infrared camera lens, a wide-angle lens, and a telephoto lens) and image sensors may be disposed on one surface of the electronic device 100.

The key input devices 117 may be disposed on the side surface 110C of the housing 110. In an embodiment, the electronic device 100 may not include all or part of the above-mentioned key input devices 117, and a key input device 117, which is not included in the electronic device 300, may be implemented in another form, such as a soft key, on the display 101. In various embodiments, a key input device may include a sensor module 116 disposed on the second surface 110B of the housing 110.

The light-emitting elements 106 may be disposed, for example, on the first surface 110A of the housing 110. The light-emitting elements 106 may provide, for example, information about the state of the electronic device 100 in an optical form. In an embodiment, the light-emitting elements 106 may provide a light source that is interlocked with, for example, the operation of the camera module 105. The light-emitting elements 106 may include, for example, an LED, an IR LED, and a xenon lamp.

The connector holes 108 and 109 may include a first connector hole 108, which is capable of accommodating a connector (e.g., a USB connector) for transmitting/receiving power and/or data to/from an external electronic device, and/or a second connector hole 109, which is capable of accommodating a connector (e.g., an earphone jack) for transmitting/receiving an audio signal to/from an external electronic device.

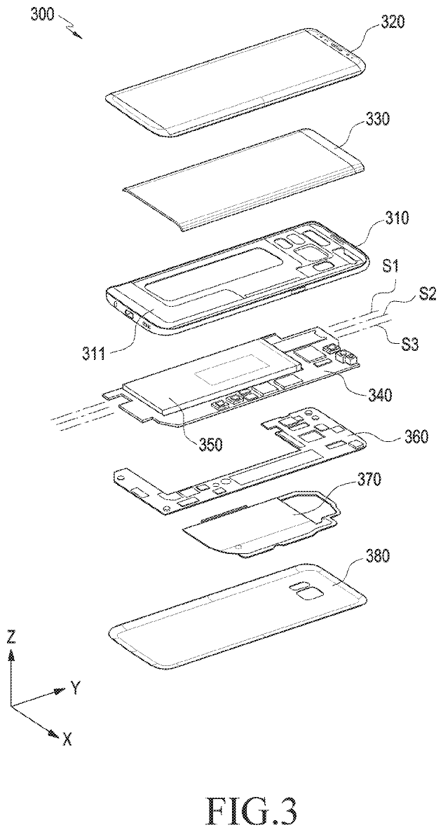

FIG. 3 is an exploded perspective view illustrating the electronic device 300 illustrated in FIG. 1 (e.g., the electronic device 100 in FIG. 1 and/or FIG. 2) according to various embodiments.

Referring to FIG. 3, the electronic device 300 may include a side bezel structure 310, a first support member 311 (e.g., a bracket), a front plate 320, a display 330, a printed circuit board 340, a battery 350, a second support member 360 (e.g., a rear case), an antenna 370, and a rear plate 380. In various embodiments, in the electronic device 300, at least one of the components (e.g., the first support member 311 or the second support member 360) may be omitted, or other components may be additionally included. At least one of the components of the electronic device 300 may be the same as or similar to at least one of the components of the electronic device 100 of FIG. 1 or 2, and a redundant description thereof may not be repeated below.

The first support member 311 may be disposed inside the electronic device 300 to be connected to the side bezel structure 310, or may be formed integrally with the side bezel structure 310. The first support member 311 may be formed of, for example, a metal material and/or a non-metal material (e.g., a polymer). The display 330 may be coupled to one surface of the first support member 311, and the printed circuit board 340 may be coupled to the other surface of the first support member 311. On the printed circuit board 340, a processor, a memory, and/or an interface may be mounted. The processor may include one or more of, for example, a central processing unit, an application processor, a graphics processor, an image signal processor, a sensor hub processor, or a communication processor.

The memory may include, for example, a volatile memory or a nonvolatile memory.

The interface may include, for example, a high-definition multimedia interface (HDMI), a universal serial bus (USB) interface, an SD card interface, and/or an audio interface. The interface may electrically or physically connect, for example, the electronic device 300 to an external electronic device, and may include a USB connector, an SD card/MMC connector, or an audio connector.

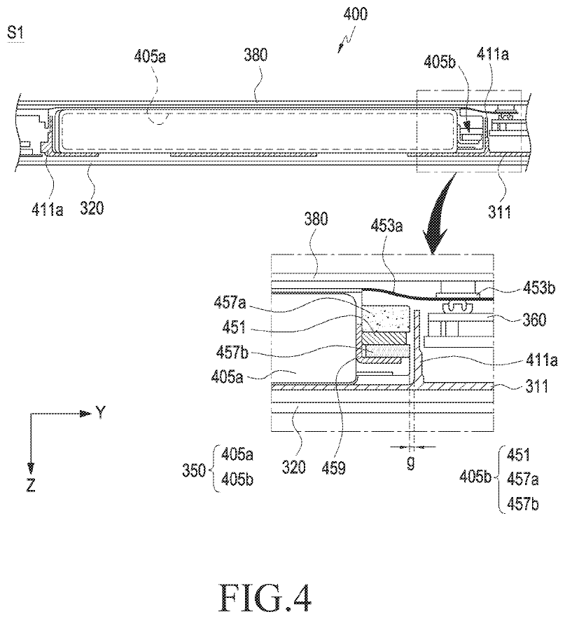

The battery 350 is a device for supplying power to at least one component of the electronic device 300, and may include, for example, and without limitation, a non-rechargeable primary battery, a rechargeable secondary battery, a fuel cell, or the like. At least a portion of the battery 350 may be disposed on substantially the same plane as, for example, the printed circuit board 340. The battery 350 may be integrally disposed inside the electronic device 300, or may be detachably disposed on the electronic device 300. As will be described in greater detail below, the battery 350 may include a battery cell and a circuit board assembly (e.g., the battery cell 405a and the circuit board assembly 405b in FIG. 4), and the circuit board assembly may include a charge protective circuit. For example, the battery 350 may be substantially implemented as a rechargeable secondary battery. The configuration of the circuit board assembly will be described in more detail with reference to FIGS. 4 to 14.

The antenna 370 may be disposed between the rear plate 380 and the battery 350. The antenna 370 may include, for example, a near field communication (NFC) antenna, a wireless charging antenna, and/or a magnetic secure transmission (MST) antenna. The antenna 370 may perform short-range communication with, for example, an external electronic device, or may transmit/receive power required for charging to/from the external device in a wireless manner. In an embodiment, an antenna structure may include a portion of the side bezel structure 310 and/or the first support member 311, or a combination thereof.

In the following detailed description, reference may be made to the electronic devices 100, 200 and 300 of the preceding embodiments as needed, the same reference numbers in the drawings may be given or omitted for configurations that can be easily understood through the preceding embodiments, and a detailed description thereof may not be repeated.

FIG. 4 is a cross-sectional view illustrating an example configuration of an electronic device 400 (e.g., the electronic devices 100 and 300 in FIGS. 1 to 3) in the state in which a battery 350 (e.g., the battery 350 in FIG. 3) according to various embodiments.

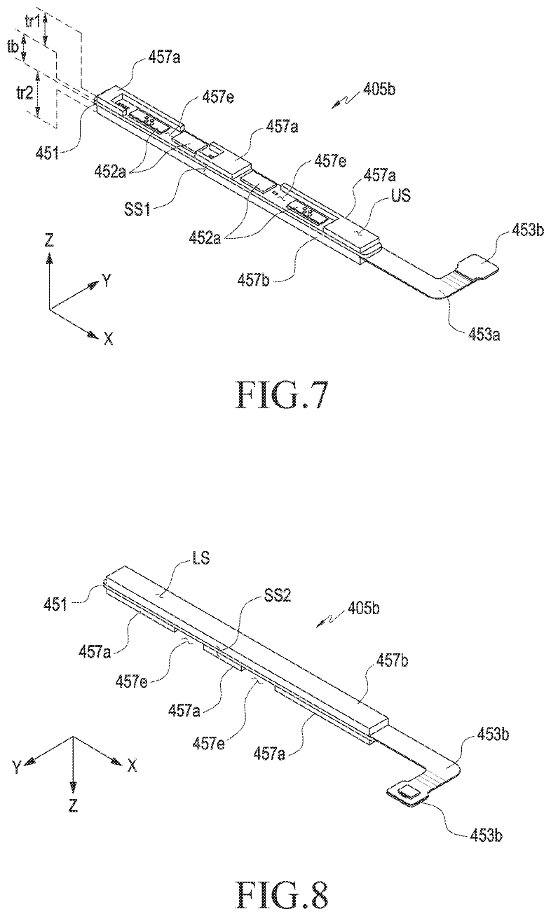

FIG. 4 illustrates, for example, a cross section of the electronic device 300 taken along line 51 in FIG. 3. Referring to FIG. 4, the battery 350 and/or the electronic device 400 including the same may include a battery cell 405a and a circuit board assembly 405b, wherein the circuit board assembly 405b may have an area greater than a general printed circuit board (e.g., a protective circuit board 451 to be described in greater detail below) in a first side surface (e.g., the first side surface 551 in FIG. 7) disposed to face the battery cell 405a in the longitudinal direction or the width direction of the electronic device 400 (and/or the battery cell 350). For example, in the Z-axis direction, the circuit board assembly 405b may be at least partially thicker than the protective circuit board 451. In the illustrated embodiment, the first side surface SS1 is disposed to face the battery cell 405a in the Y-axis direction, but various embodiments of the disclosure are not limited thereto. According to the design of the electronic device 400, the first side surface SS1 may be disposed to face the battery cell 405a in the X-axis direction. According to an embodiment, when the circuit board assembly 405b moves due to an external impact and comes into contact with the battery cell 405a, the first side surface SS1 may be brought into contact with the battery cell 405a. For example, in a situation in which an impact is applied to the battery cell 405a via the circuit board assembly 405b, the circuit board assembly 405b may be brought into contact with the battery cell 405a via the first side surface SS1. Thus, it is possible to prevent and/or reduce the impact applied to the cell 405a from being concentrated in a narrow area. Since the external impact is distributed over a large area, the battery cell 405a can be protected from the risk of being damaged by the external impact.

According to various embodiments, although not denoted by a reference numeral, the battery 350 may include an enclosure or shell, and the battery cell 405a and circuit board assembly 405b may be disposed in the interior space of the enclosure or shell. The battery 350 is a rechargeable secondary battery, and the circuit board assembly 405b may include at least one electric/electronic component (e.g., an integrated circuit chip, a passive element, and/or an active element) including therein a charge protective circuit such as an overcharge prevention circuit. In an embodiment, the circuit board assembly 405b may include a bonding member 459 for attaching the protective circuit board 451 to the battery cell 405a. The bonding member 459 may include, for example, a double-sided tape or an elastic body (e.g., a sponge coated with an adhesive material on both sides), and the protective circuit board 451 may be attached to one side surface of the battery cell 405a by the bonding member 459. For example, the protective circuit board 451 may be accommodated in the enclosure or shell in the state of being coupled to the battery cell 405a. When made of an elastic material, the bonding member 459 may function as a shock absorbing member between the battery cell 405a and the circuit board assembly 405b. It is noted that the thickness of the bonding member 459 is exaggerated for convenience of description in the illustrated embodiment. For example, the bonding member 459 may be manufactured to have a thickness substantially equal to or smaller than that of a flexible printed circuit board (e.g., the first circuit wiring 453a).

According to various embodiments, the battery 350 may be disposed on a first support member (e.g., the first support member 311 in FIG. 3). In an embodiment, the first support member 311 may include a guide rib or partition 411a that at least encloses and/or defines a space for accommodating the battery 350. In an embodiment, the guide rib or partition 411a protrudes from one surface (e.g., a surface facing the −Z-axis direction) of the first support member 311 and may substantially and at least partially surround the side surface of the battery 350. For example, the guide rib or partition 411a may at least partially separate the space in which the battery 350 is disposed from other spaces so that the surrounding structures or electric/electronic components can be inhibited from coming into direct contact with the battery 350.

According to various embodiments, a gap g of a predetermined size may be provided between the battery 350 and the partition (or guide rib) 411a. The gap g may prevent the partition (or guide rib) 411a from interfering with the battery 350 when assembling the battery 350. For example, a predetermined distance may exist between components disposed inside the electronic device 400 to prevent and/or reduce damage due to interference during an assembly process. In various embodiments, the gap g of the predetermined size may be utilized as a margin space that ensures stable assembly even if the components of the electronic device 400 are manufactured with maximum values in allowable tolerance. The gap g has a size predetermined in the design stage of the electronic device 400, but may have various sizes depending on the actually manufactured electronic device 400. In various embodiments, the battery 350 in the actually manufactured electronic device 400 may be disposed to be in contact with the partition (or guide rib) 411a. In this case, the gap g may have a value of “0 (zero)”. In an embodiment, when the gap g of the predetermined size exists, a low-density elastic body such as a sponge may be disposed in the gap g.

According to various embodiments, the circuit board assembly 405b may include one or more reinforcing member 457a, 457b, 457c, and 457d (refer to FIG. 6). In an embodiment, the reinforcing members 457a, 457b, 457c, and 457d may be respectively disposed on one surface and/or the other surface of the protective circuit board 451. The reinforcing members 457a, 457b, 457c, and 457d may make at least a surface area of the first side surface SS1 (e.g., the surface of the circuit board assembly 405b disposed to face the battery cell 405a) larger than the side surface of the protective circuit board 451. For example, in a general circuit board assembly, the side surface of the protective circuit board 451 is disposed to substantially face the battery cell 405a. However, in the battery 350 and/or the electronic device 400 according to various embodiments disclosed herein, the first side surface SS1 of the circuit board assembly 405b may be disposed to face the battery cell 405a by being combined with the side surface of the protective circuit board 451 and the surface area provided or formed by the reinforcing members 457a, 457b, 457c, and 457d. In an embodiment, when the circuit board assembly 405b is brought into contact with the battery cell 405a due to an external impact, the first side surface SS1 may be brought into contact with the battery cell 405a.

According to various embodiments, the reinforcing members 457a, 457b, 457c, and 457d may include a first reinforcing member 457a disposed on the top surface (e.g., the surface facing the +Z-axis direction) of the protective circuit board 451 and/or a second reinforcing member 457b disposed on the bottom surface (e.g., the surface facing the −Z-axis direction) of the protective circuit board 451. In various embodiments, a third reinforcing member 457c, which will be described with reference to FIG. 6, may be a portion of the first reinforcing member 457a, and a fourth reinforcing member 457d may be a portion of the second reinforcing member 457b. The first reinforcing member 457a and/or the second reinforcing member 457b may provide a surface area larger than that of the side surface of the protective circuit board 451 at least on the first side surface SS1.

According to various embodiments, the circuit board assembly 405b may be connected to a main circuit board (e.g., the printed circuit board 360 in FIG. 3) of the electronic device 400 via first connection wiring 453a (e.g., a flexible printed circuit board) and a connector 453b provided in the first connection wiring 453a. For example, one end of the first connection wiring 453a is connected to the printed circuit board 360 and the other end is connected to the protective circuit board 451 so that the circuit board assembly 405b can be connected to the main circuit board of the electronic device 400. In various embodiments, the first connection wiring 453a may substantially extend from the protective circuit board 451. For example, the first connection wiring 453a may be connected to the protective circuit board 451 without a separate connector.

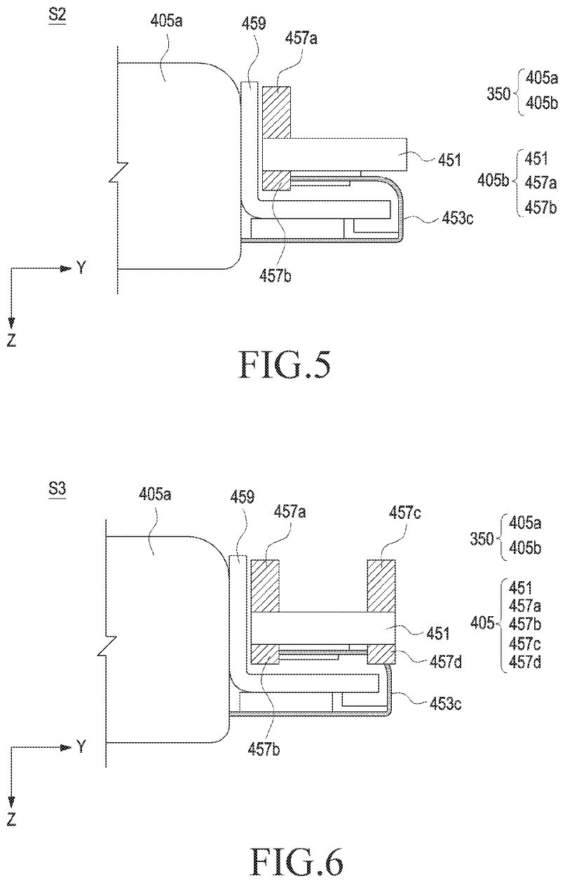

FIG. 5 is an enlarged view of a portion of the battery 350 of the electronic device (e.g., the electronic device 400 of FIG. 4) according to various embodiments. FIG. 6 is an enlarged view of another portion of the battery 350 of the electronic device 400 according to various embodiments.

FIG. 5 is an enlarged illustration of, for example, a portion of a cross section of the electronic device 300 taken along “line S2” in FIG. 3 according to various embodiments, and FIG. 6 is, for example, an enlarged illustration of a portion of a cross section of the electronic device taken along “line S3” in FIG. 3 according to various embodiments.

Referring to FIGS. 5 and 6, the circuit board assembly 405b may include second connection wiring 453c to electrically connect the protective circuit board 451 to the battery cell 405a. The electronic device 300 or 400, for example, a processor or a power management module, may be configured to charge the battery 350 by receiving external power or to operate using the power of the battery 350 when the external power is not supplied. For example, the battery cell 405a may receive charging power via the protective circuit board 451 and/or the main circuit board (e.g., the printed circuit board 360 in FIG. 4) or may provide power for operating the electronic device 300 or 400.

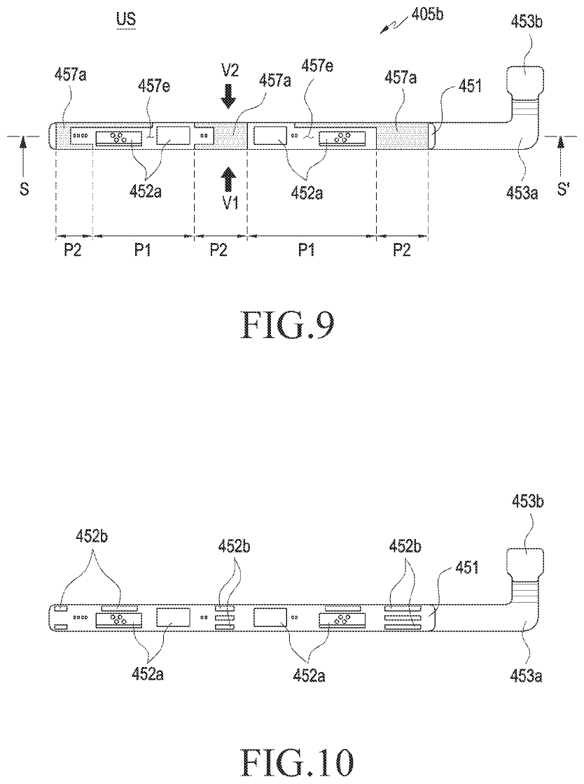

According to various embodiments, the reinforcing members 457a, 457b, 457c, and 457d may include a first reinforcing member 457a and/or a third reinforcing member 457c disposed on the top surface of the protective circuit board 451, and a second reinforcing member 457b and/or a fourth reinforcing member 457d disposed on the bottom surface of the protective circuit board 451. As will be discussed in greater detail below with reference to FIG. 7 or FIG. 9, the third reinforcing member 457c may be substantially a portion of the first reinforcing member 457a, and the fourth reinforcing member 457d may be a portion of the second reinforcing member 457b. For example, in the protective circuit board 451, the shape of the first reinforcing member 457a (and/or the shape of the second reinforcing member 457b) may vary depending on a cut position. In an embodiment, the first reinforcing member 457a and the third reinforcing member 457c may be provided as separate components, and the second reinforcing member 457b and the fourth reinforcing member 457d may be provided as separate components. In the following description, for the sake of brevity of description, a reinforcing member disposed on the top surface of the protective circuit board 451 may be referred to as a “first reinforcing member 457a”, and a reinforced member disposed on the bottom surface of the protective circuit board 451 may be referred to as a “second reinforcing member 457b”. In various embodiments, when the space in which the circuit board assembly 405b can be accommodated is limited, for example, when the accommodation space in the thickness direction (e.g., the Z-axis direction) is insufficient, any one of the first reinforcing member 457a and the second reinforcing member 457b may be omitted. When any one of the first reinforcing member 457a and the second reinforcing member 457b is disposed, reinforcing members 457a or 457b, which is easy to expand the surface area for dispersing the impact, may be selected or may be disposed on the protective circuit board 451.

According to various embodiments, the first reinforcing member 457a may be located at an end of the top surface of the protective circuit board 451 in the −Y-axis direction, and the third reinforcing member 457c may be located at an end of the top surface of the protective circuit board 451 in the +Y-axis direction. In various embodiments, the second reinforcing member 457b may be located at an end of the bottom surface of the protective circuit board 451 in the −Y-axis direction while overlapping the first reinforcing member 457a in the Z-axis direction. Similarly, the fourth reinforcing member 457d may be located at an end of the bottom surface of the protective circuit board 451 in the +Y-axis direction while overlapping the third reinforcing member 457c in the Z-axis direction. According to an embodiment, the first reinforcing member 457a and/or the second reinforcing member 457b may flush with the side surface of the protective circuit board 451 at the end in the −Y-axis direction. For example, on the side surface facing the battery cell 405a (e.g., the first side surface SS1 in FIG. 7), the circuit board assembly 405b may have a larger surface area than that of the side surface of the protective circuit board 451.

According to various embodiments, the circuit board assembly 405b may have an expanded surface area on the side surface (e.g., the surface facing the −Y-axis direction in FIG. 5 or FIG. 6) that may come into contact with the battery cell 405a due to an external impact so that it is possible to mitigate or prevent damage to the battery cell 405a by dispersing the external impact. For example, in FIG. 5 and/or FIG. 6, when an impact is applied to the battery cell 405a in the −Y-axis direction, the impact can be dispersed by the circuit board assembly 405b. According to an embodiment, when an impact is applied in the −Y-axis direction, the circuit board assembly 405b may be disposed such that the side surface in which the reinforcing members 457a and 457b and the protective circuit board 451 are combined is in contact with the battery cell 405. For example, in order to prevent and/or mitigate the impact from being concentrated on the portion (e.g., the contact portion of the battery cell 405b) that is in contact with the side surface (e.g., the first side surface SS1 in FIG. 7) of the protective circuit board 451, the circuit board assembly 405b may disperse the impact over a large area using the reinforcing members 457a and 457b.

FIG. 7 is a perspective view illustrating the top surface of the circuit board assembly 405b in the battery 350 of the electronic device (e.g., the electronic device 400 in FIG. 4) according to various embodiments. FIG. 8 is a perspective view illustrating the bottom surface of the circuit board assembly 405b in the battery 350 of the electronic device 400 according to various embodiments. FIG. 9 is a plan view illustrating the top surface of the circuit board assembly 405b in the battery 350 of the electronic device 400 according to various embodiments.

Referring to FIGS. 7, 8 and 9, the circuit board assembly 405b may include a first side surface SS1 disposed to face the battery cell 405a, and the first side surface SS1 is, for example, a surface facing the −Y-axis direction in the electronic device 400. In an embodiment, the circuit board assembly 405b may include a second side surface SS2 disposed to face away from the first side surface SS1, and the second side surface SS2 may be substantially parallel to the first side surface SS1.

According to various embodiments, the circuit board assembly 405b may include a protective circuit board 451 and reinforcing members 457a and 457b, and may include a first part P1 having a first thickness in the thickness direction (e.g., the Z-axis direction) perpendicular to the longitudinal direction (e.g., the X-axis direction) or the width direction (e.g., the Y-axis direction), and at least one second part P2 having a second thickness greater than the first thickness. It is noted that in the description with reference to FIGS. 7, 8 and 9, the longitudinal direction is defined as the X-axis direction and the width direction is defined as the Y-axis direction in consideration of the length or the width of the circuit board assembly. In describing various embodiments, the longitudinal direction of the electronic device may be defined as the Y-axis direction, and the width direction of the electronic device may be defined as the X-axis direction. In an embodiment, the first thickness may be set to the thickness of the protective circuit board 451, and/or the second thickness may be set to the sum of the thickness of the protective circuit board 451 and the thickness of the first reinforcing member 457a In an embodiment, the first thickness may be set to the sum of the thickness of the protective circuit board 451 and the thickness of the second reinforcing member 457b, and/or the second thickness may be set to the sum of the thickness of the protective circuit board 451, the thickness of the first reinforcing member 457a, and the thickness of the second reinforcing member 457b. For example, the protective circuit board 451 may provide or form at least a portion of the first part P1 and a portion of the second part P2, and the reinforcing members 457a and 457b may provide or form the second part P2 together with the protective circuit board 451.

In the embodiment illustrated in FIGS. 7, 8 and 9, since a plurality of first reinforcing members 457a are disposed on the top surface of the protective circuit board 451, the upper surface of the circuit board assembly 405b may have a height difference in the thickness direction (e.g., the Z-axis direction). In the illustrated embodiment, one second reinforcing member 457b may be disposed on substantially the entire bottom surface of the protective circuit board 451. For example, in the embodiment illustrated in FIGS. 7, 8 and 9, the first thickness may be set to the sum of the thickness tb of the protective circuit board 451 and the thickness tr2 of the second reinforcing member 457b, and/or the second thickness may be set to the sum of the thickness tb of the protective circuit board 451, the thickness tr1 of the first reinforcing member 457a, and the thickness tr2 of the second reinforcing member 457b. As will be discussed with reference to FIG. 14, a plurality of second reinforcing members 557b may be disposed on the bottom surface of the protective circuit board 451. In this case, the first thickness may be set to the thickness tb of the protective circuit board 451, and the second thickness may be set to the sum of the thickness tb of the protective circuit board 451, the thickness tr1 of the first reinforcing member 457a, and the thickness tr2 of the second reinforcing member 557b.

According to various embodiments, the first side surface SS1 may connect at least a portion of the upper surface US of the circuit board assembly 405b to at least a portion of the lower surface LS of the circuit board assembly 405b, and may be disposed to face the battery cell 405a in the electronic device 400. A portion of the second part P2 may provide or form at least a portion of the first side surface SS1. For example, at least a portion of the surfaces of the first reinforcing member 457a and/or the second reinforcing member 457b may be disposed on one plane with the side surface of the protective circuit board 451, thereby providing or forming the first side surface SS1. In an embodiment, the second side surface SS2 may connect another portion of the upper surface US of the circuit board assembly 405b to another portion of the lower surface of the circuit board assembly 405b, and may include another portion of the surface of the second part P2 (e.g., the surfaces of the reinforcing members 457a and 457b). The second side surface SS2 may be disposed in a direction substantially facing at least a portion of the guide rib or partition (e.g., the partition 411a in FIG. 4) in the electronic device 400.

According to various embodiments, a configuration in which a gap (e.g., the gap g in FIG. 4) of a predetermined size is provided between the guide rib or partition 411a and the battery 350 in order to facilitate the assembly of the battery 350 has been described with reference to FIG. 4. This gap g may allow the battery 350 to move within the electronic device 400 when an external impact is applied. For example, when the battery 350 moves due to an external impact, the battery 350 may collide with the guide rib or partition 411a. A secondary impact generated by the collision with the partition 411a may be transferred to the battery cell 405a via the circuit board assembly 405b. This secondary impact may be absorbed or alleviated by the reinforcing members 457a and 457b on the second side surface SS2, rather than being directly applied to the protective circuit board 451. For example, the reinforcing members 457a and 457b may disperse the impact force by expanding an area to which at least the secondary impact is applied. In various embodiments, the reinforcing members 457a and 457b may be configured to come into contact with the guide rib or partition 411 before the protective circuit board 451 to at least partially absorb the secondary impact. As described above, the first side surface SS1 and/or the second side surface SS2 may partially include the second part P2, and in the first side surface SS1 and/or the second side surface SS2, the second part P2 may substantially function as a region for dispersing the impact transmitted to the battery 350 and/or the battery cell 405a.

According to various embodiments, the circuit board assembly 405b may include at least one arrangement space 457e. The arrangement space 457e is a space at least partially surrounded by the first reinforcing members 457a and/or the second part P2, and may be disposed on at least one surface of the protective circuit board 451 between the first side surface SS1 and the second side surface SS2. For example, in the structure in which the plurality of first reinforcing members 457a are disposed, at least one arrangement space 457e may be provided on the top surface of the protective circuit board 451, and/or a plurality of second reinforcing members 457b may be disposed on the bottom surface the protective circuit board 451 to provide at least one arrangement space (e.g., the arrangement space 557e in FIG. 14). According to an embodiment, the arrangement space 457e is a space provided since the reinforcing members 457a and 457b are not substantially disposed on one or both surfaces of the protective circuit board 451, and may be surrounded by a portion of the protective circuit board 451 and/or at least a portion of the first part P1. In various embodiments, the circuit board assembly 405b may include one or more electric/electronic components 452a disposed in the arrangement space 457e, e.g., disposed on the protective circuit board 451 in the arrangement space 457e. The electric/electronic components 452a may include, for example, an integrated circuit chip in which a charge protective circuit is incorporated, and may further include a passive element and/or an active element. In an embodiment, the electric/electronic components 452a may include a tab or a conductive pad to which a lead(s) extending from the battery cell 405a is (are) connected or coupled.

According to various embodiments, a battery control circuit configured to protect the battery may be located on the protective circuit board 451. The battery control circuit may include a circuit configured protect the battery from a sudden change in an electrical signal applied to the battery (e.g., the battery cell 405a) due to a phenomenon such as a short circuit. In addition, a sensing circuit capable of measuring states of the battery, such as battery life, discharge time, number of times of charging and discharging, life prediction, and battery resistance, may be located on the protective circuit board 451. Such a sensing circuit may be referred to as, for example, a fuel gage. The protective circuit board 451 may be electrically connected to the battery cell 405a via one or more electrode tabs (e.g., a first electrode tab and a second electrode tab). For example, the first electrode tab may be connected to the positive electrode tab of the battery cell 405a, and the second electrode tab may be connected to the negative electrode tab of the battery cell 405a. The sensing circuit located on the protective circuit board 451 may be electrically connected to the battery cell 405a to measure the states of the battery cell 405a.

According to various embodiments, the reinforcing members 457a and 457b may be made of an electrically conductive material. For example, the reinforcing members 457a and 457b may be located on the protective circuit board 451 and used as ground conductors. However, various embodiments of the disclosure are not limited thereto, and the material of the reinforcing members 457a and 457b may be variously selected as long as an impact applied to the battery cell 405a can be dispersed when an external impact is applied. When the reinforcing members 457a and 457b are made of an electrically conductive material, the reinforcing members 457a and 457b may be located on the protective circuit board 451 through a surface mounting technology (SMT).

FIG. 10 is a plan view illustrating the state in which the reinforcing members 457a of the circuit board assembly 405b have been removed from the battery (e.g., the battery 350 in FIG. 4) of the electronic device (e.g., electronic device 400 in FIG. 4) according to various embodiments.

Referring to FIG. 10, when the reinforcing members 457a and 457b are disposed on the protective circuit board 451 through a surface mounting process, bonding pads 452b may be provided in a region (e.g., a region included in the second part P2) in which electric/electronic components are not disposed on the surface of the protective circuit board 451. In various embodiments, the bonding pads 452b may include an adhesive for attaching the reinforcing members 457a and 457b to the protective circuit board 451. In an embodiment, the bonding pads 452b may be metal pads to which solder paste is applied in a surface mounting process, and may be electrically connected to a ground plane provided in the protective circuit board 451. For example, the reinforcing members 457a and 457b may be disposed in a region of the protective circuit board 451 in which electric/electronic components are not disposed, and may be electrically connected to a ground plane provided in the protective circuit board 451.

According to various embodiments, the reinforcing members 457a and 457b may be substantially a portion of the protective circuit board 451. For example, a structure corresponding to the reinforcing members 457a and 457b of the above-described embodiment may be provided by laminating an insulating layer and/or a dielectric layer in the region in which the electric/electronic components 452a are not disposed on the protective circuit board 451. The insulating layer and/or dielectric layer provided as a structure corresponding to the reinforcing members 457a and 457b of the above-described embodiment may be made of the same material as the insulating layer and/or the dielectric layer provided on the protective circuit board 451 of the above-described embodiment. However, various embodiments of the disclosure are not limited thereto, and as mentioned above, the material of the reinforcing members 457a and 457b or the reinforcing layer to be described later can be variously changed as long as an impact applied to the battery cell 405a can be dispersed. The structure that is a portion of the protective circuit board 451 and corresponds to the above-described reinforcing members will be referred to as a “reinforcement layer” in order to distinguish the structure from the reinforcing members 457a and 457b configured to be bonded or mounted. In various embodiments, a “reinforcing member” may include a “reinforcing layer” to be described in greater detail below.

A structure in which a reinforcing member and/or a reinforcing layer is provided as a portion of the protective circuit board 451 rather than being separately mounted or attached is illustrated by way of example in Table 1 below. However, various embodiments of the disclosure are not limited thereto, and the number or functions of layers may be variously changed depending on electric/electronic components located on the protective circuit board, and the materials of respective elements may be appropriately selected in consideration of the functions or uses of respective layers.

TABLE 1

| | | | Thickness |
|---|---|---|---|
| Layer | Configuration | | (micrometer) |
| Reinforcing layer | FR4 | | 400-2000 |
| 1^{st} layer | Solder resist | | 30 |
| | Copper plating | | 25 |
| | Copper coating | | 35 |
| Intermediate | Prepreg | | 110 |
| adhesive | | | |
| Intermediate | Prepreg | | 110 |
| adhesive | | | |
| 2^{nd} layer/3^{rd} layer | Coverlay | Polyimide | |
| | | Adhesive | |
| | Copper plating | | 19 |
| | Base | Copper | 35 |
| | | Polyimide | 20 |
| | | Copper | 35 |
| | Copper plating | | 19 |
| | Coverlay | Adhesive | |
| | | Polyimide | |

| | | |
|---|---|---|
| Intermediate | Prepreg | 110 |
| adhesive | | |
| Intermediate | Prepreg | 110 |
| adhesive | | |
| 4^{st} layer | Copper coating | 35 |
| | Copper plating | 25 |
| | Solder resist | 30 |
| Reinforcing layer | FR4 | 400-2000 |

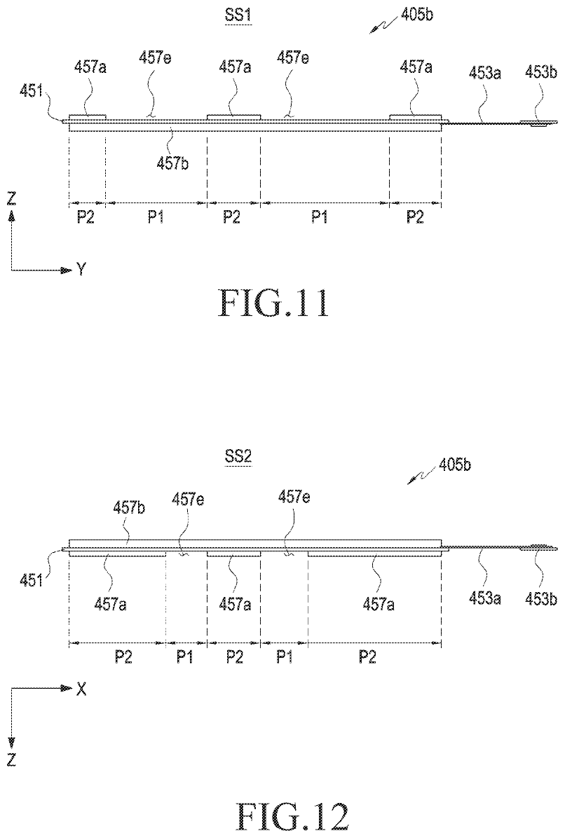

In various embodiments, the reinforcing layers of Table 1 may be bonded to the first layer and/or the fourth layer of the protective circuit board 451 by an adhesive, which may be a part of a lamination or stacking process in the protective circuit board 451 manufacturing process. By providing the reinforcing layers, it is possible to provide partially recessed regions on the top surface and/or the bottom surface of the protective circuit board 451, and it is possible to use the recessed regions as, for example, the arrangement spaces 457e of FIGS. 7, 8 and 9. In an embodiment, the protective layers of Table 1 may substantially correspond to the reinforcing members 457a and 457b of FIGS. 7, 8 and 9. For example, in various embodiments, the protective circuit board itself may include a circuit board assembly including a protective layer, and in other embodiments, the circuit board assembly may include reinforcing members disposed or mounted on the protective circuit board through a separate assembly process such as a surface mounting process. FIG. 11 is a view illustrating the configuration of the first side surface (e.g., the first side surface SS1 in FIG. 7) of the circuit board assembly 405b in the battery 350 of the electronic device (e.g., the electronic device 400 in FIG. 4) according to various embodiments.

FIG. 11 is a view illustrating a shape viewed in the direction V1 in FIG. 9 according to various embodiments. It is noted that, when viewed in the direction V1, some components, such as electric/electronic components 452a, may be actually seen, but FIG. 11 illustrates the shape of the first side surface SS1 omitting these components. The first side surface SS1 may be provided or formed by substantially disposing a portion of the reinforcing members 457a and 457b and one side surface of the protection circuit board 451 on a single plane. In various embodiments, the second part P2 in the first side surface SS1 may be defined as a portion in which the first reinforcing members 457a are disposed, and at least a portion of the arrangement space 457e may be exposed to the outside in the state of being in contact with the second part P2. For example, in the first side surface SS1, the arrangement space 457e may be partially hidden by the first reinforcing members 457a, and the other portions may be exposed through spaces between the first reinforcing members 457a. In an embodiment, compared to a structure in which the reinforcing members 457a and 457b are not disposed, the area for transmitting an impact in the circuit board assembly 405b including the reinforcing members 457a and 457b may be increased. For example, in the battery (e.g., the battery 350 in FIG. 3 or 4) and/or the electronic device (e.g., the electronic device 100, 300, and 400 in FIGS. 1 to 4) according to various embodiments disclosed herein, a region or an area in which the circuit board assembly 405b and the battery cell 405a can be brought into contact with each other is expanded, which makes it possible to disperse the impact transferred to the battery cell 405a via the circuit board assembly 405b.

FIG. 12 is a view illustrating the configuration of the second side surface (e.g., the second side surface SS2 in FIG. 8) of the circuit board assembly 405b in the battery 350 of the electronic device (e.g., the electronic device 400 in FIG. 4) according to various embodiments.

FIG. 12 is a view illustrating a shape viewed in the direction V2 in FIG. 9. It is noted that, when viewed in the direction V2, some components, such as electric/electronic components 452a, may be actually visible, but FIG. 12 illustrates the shape of the second side surface SS2 omitting the above-mentioned components. The second side surface SS2 may be provided or formed by substantially disposing a portion of the reinforcing members 457a and 457b and the other side surface of the protection circuit board 451 on a single plane. In various embodiments, the second part P2 in the second side surface SS2 may be defined as a portion in which the first reinforcing members 457a are disposed, and at least a portion of the arrangement space 457e may be exposed to the outside in the state of being in contact with the second part P2. For example, in the second side surface SS2, the arrangement space 457e may be partially hidden by the first reinforcing members 457a, and the other portions may be exposed through spaces between the first reinforcing members 457a. In an embodiment, the reinforcing members 457a and 457b may be disposed to receive an impact from another structure (e.g., the partition 411a in FIG. 4) before the protective circuit board 451 to absorb or alleviate the impact. By expanding the area or area that receives the impact from other structures, it is possible to disperse the impact applied from the outside.

According to various embodiments, when the second side surface SS2 is viewed through the first side surface SS1, for example, when the second side surface SS2 is viewed through the first side surface SS1 in the direction V1 of FIG. 9, a region of the second part P2 area included in the first side surface SS1 and a region of the second part P2 included in the second side surface SS2 may at least partially overlap each other. For example, a portion of the first side surface SS1 and a portion of the second side surface SS2 provided or formed by the second reinforcing member 457b may substantially overlap each other when the second side surface SS2 is viewed through the first side surface SS1. In an embodiment, a portion of the first side surface SS1 provided or formed by the first reinforcing members 457a and a portion of the second side surface SS2 provided or formed by the first reinforcing member 457a may at least partially overlap each other when the second side surface SS2 is viewed through the first side surface SS1. A region which corresponds to the portion of the first side surface SS1 and the portion of the second side surface SS2 overlapping each other may be referred to as a “first overlapping region” below.

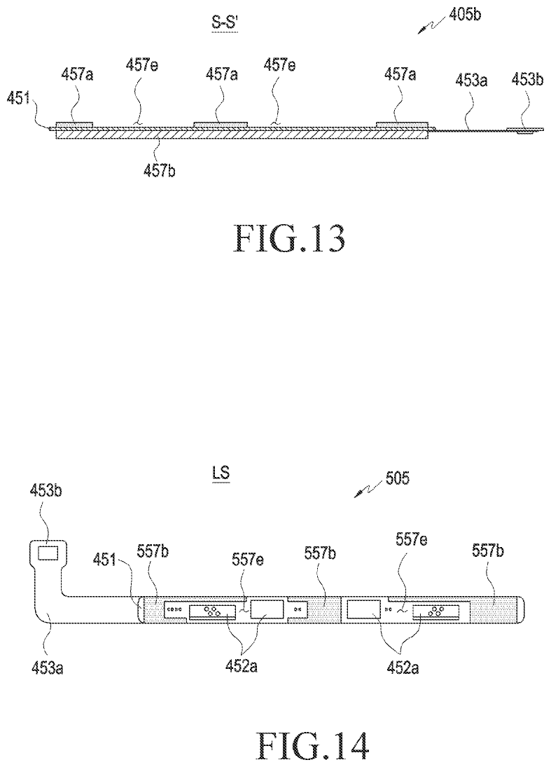

FIG. 13 is a cross-sectional view taken by cutting a portion of the circuit board assembly 405b in the battery 350 of the electronic device (e.g., the electronic device 400 in FIG. 4) according to various embodiments.

FIG. 13 is a cross-sectional configuration view illustrating the circuit board assembly 405b taken along line S-S′ in FIG. 9. It is noted that some components, such as electric/electronic components 452a, may be actually visible, but FIG. 13 illustrates the cross-sectional shapes of the protective circuit board 451 and the reinforcing members 457a and 457b omitting the above-mentioned components. As illustrated in FIG. 13, the cross section of the first reinforcing members 457a cut at an arbitrary position between the first side surface SS1 and the second side surface SS2 may have a length in the X-axis direction shorter than that in the first side surface and/or that in the second side surface. In an embodiment, cross sections of the first reinforcing members 457a cut at arbitrary positions between the first side surface SS1 and the second side surface SS2 may be substantially located within the first overlapping region. The cross sections of the first reinforcing members 457a cut at arbitrary positions between the first side surface SS1 and the second side surface SS2 may be disposed, in the width direction of the protective circuit board (e.g., the Y-axis direction), to overlap a region of the first side surface SS1 disposed to come into contact with the battery cell 405a and/or a region of the second side surface SS2 disposed to receive an impact before other structures (e.g., the protective circuit board 451).

According to various embodiments, the cross-sectional shapes of the first reinforcing members 457a and/or the second reinforcing member(s) 457b have shapes capable of dissipating impacts in the path through which the impacts are transferred from the second side surface SS2 to the first side surface SS1. For example, in a structure having no reinforcing members 457a and 457b, the impacts may be intensively transferred substantially via the protective circuit board 451. However, by disposing the reinforcing members 457a and 457b, it is possible to diversify the paths through which impact are transferred or locations to which impacts are applied and to widen a contact or impact area in an unavoidable contact or contact situation, thereby dispersing the impacts.

As described above, with the battery 350 and/or the electronic device 100, 300, or 400 according to various embodiments disclosed herein, using the reinforcing members 457a and 457b on the protective circuit board 451, when impacts are transferred to the battery cell 405a via the circuit board assembly 405b disposed in the battery 350, it is possible to diversify the paths through which the impacts are transferred or the locations to which the impacts are applied or to increase the area to which the impacts are applied, thereby dispersing the impacts. For example, in the battery 350 and/or the electronic device 100, 300, or 400 according to various embodiments disclosed herein, damage to the battery 350 and/or the battery cell 405a due to an external impact can be alleviated or prevented, and the reliability of the battery 350 and/or the electronic device 100, 300, or 400 against an external impact can be improved.

FIG. 14 is a bottom view illustrating an example circuit board assembly 505 (e.g., the circuit board assembly 405b in FIG. 4) in the battery 350 of the electronic device (e.g., the electronic device 400 of FIG. 4) according to various embodiments.

Referring to FIG. 14, the circuit board assembly 505 may include a plurality of second reinforcing members 557b. For example, by disposing the second reinforcing members 557b on the bottom surface of the protective circuit board 451, it is possible to provide arrangement spaces 557e between the second reinforcing members 557b, and the circuit board assembly 405b may include one or more electric/electronic components 452a disposed on the protection circuit board 451 in the arrangement spaces 557e. In various embodiments, when including a plurality of second reinforcing members 557b, the circuit board assembly 505 may include a plurality of first reinforcing members 457a similar to the preceding embodiments. In an embodiment, when including a plurality of second reinforcing members 557b, the circuit board assembly 505 may include a single first reinforcing member 457a. The second reinforcing members 457b or 557b may be disposed on the bottom surface of the protective circuit board 451 via the bonding pad(s) 452b of FIG. 10.

As described above, according to various example embodiments disclosed herein, a battery (e.g., the battery 350 in FIG. 3 and/or FIG. 4) and/or an electronic device (e.g., the electronic device 100, 300, or 400 in FIGS. 1 to 4) including the same may include: a battery cell (e.g., the battery cell 405a in FIGS. 4 to 6); and a circuit board assembly (e.g., the circuit board assembly 405b or 505 in FIGS. 4 to 14) including a charge protective circuit, the circuit board assembly being disposed on one side of the battery cell, wherein the circuit board assembly includes a first side surface (e.g., the first side surface SS1 in FIG. 7) disposed in a longitudinal direction (e.g., the X-axis direction in FIG. 7 or FIG. 8) or a width direction (e.g., the Y-axis direction in FIG. 7 or FIG. 8) to face the battery cell, at least one first part (e.g., the first part P1 in FIG. 9) having a first thickness in a thickness direction (e.g., the Z-axis direction in FIG. 7 or FIG. 8) perpendicular to the longitudinal direction or the width direction, and at least one second part (e.g., the second part P2 in FIG. 9) having a second thickness greater than the first thickness, and a portion of the second part may form at least a portion of the first side surface.

According to various example embodiments, the circuit board assembly may include an upper surface (e.g., the upper surface US in FIG. 7) and a lower surface (e.g., the lower surface LS in FIG. 8) facing away from the upper surface, and the first side surface may connect at least a portion of an edge of the upper surface to at least a portion of an edge of the lower surface.

According to various example embodiments, the circuit board assembly may include an upper surface, a lower surface facing away from the upper surface, and a second side surface (e.g., the second side surface SS2 in FIG. 8) connecting a portion of an edge of the upper surface to a portion of an edge of the lower surface, and the first side surface may be disposed to face away from the second side surface and connect another portion of the edge of the upper surface to another portion of the edge of the lower surface.

According to various example embodiments, the first side surface and the second side surface may be disposed parallel to each other.

According to various example embodiments, the circuit board assembly may further include: an arrangement space (e.g., the arrangement space 457e or 557e in FIGS. 7 to 9 and/or FIGS. 11 to 14) at least partially defined in the first part between the first side surface and the second side surface; and at least one electric/electronic component (e.g., the electric/electronic component 452a in FIG. 7 or FIG. 9) disposed in the arrangement space, wherein the arrangement space may be at least partially surrounded by the second part.

According to various example embodiments, at least a portion of the arrangement space may be exposed to the outside in a state of being in contact with the second part on the first side surface or the second side surface.

According to various example embodiments, another portion of the second part may form a second dispersion area including at least a portion of the second side surface.

According to various example embodiments, when the second side surface is viewed through the first side surface, a first dispersion area and the second dispersion area at least partially overlap each other.

According to various example embodiments, the circuit board assembly may include: a protective circuit board (e.g., the protective circuit board 451 in FIGS. 4 to 14) forming at least a portion of the first part and at least a portion of the second part; and at least one reinforcing member (e.g., the reinforcing members 457a, 457b, 457c, 457d, and 557b in FIGS. 4 to 9 and/or FIGS. 11 to 14) mounted on at least one surface of the protective circuit board and forming the second part together with a portion of the protective circuit board.

According to various example embodiments, the circuit board assembly may further include: an arrangement space at least partially surrounded by the reinforcing member; and at least one electric/electronic component disposed on the protective circuit board in the arrangement space.

According to various example embodiments, at least a portion of the arrangement space is exposed to the outside on the second side surface.

According to various example embodiments, the reinforcing member may be disposed on each of opposite sides of the protective circuit board.

According to various example embodiments, the circuit board assembly may include a bonding pad (e.g., the bonding pad 452b in FIG. 10) disposed on the protective circuit board, and the reinforcing member may be bonded to the protective circuit board via the bonding pad.

According to various example embodiments, the first thickness may be set to the thickness of the protective circuit board.

According to various example embodiments, an electronic device (e.g., the electronic device 100, 300, or 400 in FIGS. 1 to 4) may include: a housing (e.g., the housing 110 in FIG. 1 and/or FIG. 2); a support (e.g., the first support member 311 in FIG. 3 and/or FIG. 4) accommodated in the housing; and a battery (e.g., the battery 350 in FIGS. 3 to 6) at least partially seated on the one surface of the support in the housing, wherein the battery may include: a battery cell (e.g., the battery cell 405a in FIGS. 4 to 6); and a circuit board assembly (e.g., the circuit board assembly 405b or 505 in FIGS. 4 to 14) including a charge protective circuit, the circuit board assembly being disposed on one side of the battery cell, and wherein the circuit board assembly may include a first side surface (e.g., the first side surface SS1 in FIG. 7) disposed in a longitudinal direction (e.g., the Y-axis direction in FIG. 3 or FIG. 4) or a width direction (e.g., the X-axis direction in FIG. 3) to face the battery cell, at least one first part (e.g., the first part P1 in FIG. 9) having a first thickness in a thickness direction perpendicular to the longitudinal direction or the width direction, and at least one second part (e.g., the second part P2 in FIG. 9) having a second thickness greater than the first thickness, and a portion of the second part may form a dispersion area which is at least a portion of the first side surface.

According to various example embodiments, the support may further include a partition (e.g., the partition 411a in FIG. 4) protruding from one surface thereof, and the circuit board assembly may be disposed between the battery cell and the partition.

According to various example embodiments, the circuit board assembly may include: a protective circuit board (e.g., the protective circuit board 451 in FIGS. 4 to 14) forming at least a portion of the first part and at least a portion of the second part; and at least one reinforcing member (e.g., the reinforcing members 457a, 457b, 457c, 457d, and 557b in FIGS. 4 to 9 and/or FIGS. 11 to 14) mounted on at least one surface of the protective circuit board and forming the second part together with a portion of the protective circuit board.

According to various example embodiments, the support may further include a partition protruding from one surface thereof and at least partially arranged at a position adjacent to the reinforcing member in a direction facing the reinforcing member.

According to various example embodiments, the circuit board assembly may further include a second side surface (e.g., the second side surface SS2) including another portion of the second part and facing away from the first side surface, and the support may further include a partition protruding from one surface thereof and at least partially arranged at a position adjacent to the reinforcing member in a direction facing the second side surface.

According to various example embodiments, the circuit board assembly may further include a bonding pad (e.g., the bonding pad 452b in FIG. 10) disposed on the protective circuit board, wherein the reinforcing member may be bonded to the protective circuit board via the bonding pad.

In the foregoing detailed description, various example embodiments have been illustrated and described. It will be understood that the various example embodiments are intended to be illustrative, not limiting. It will also be understood by one skilled in the art that various modifications can be made without departing from the scope of the disclosure.

1. A battery comprising:
a battery cell; and
a circuit board assembly including a charge protective circuit and disposed on one side of the battery cell,
wherein the circuit board assembly includes: a first side surface disposed in a longitudinal direction or a width direction to face the battery cell, at least one first part having a first thickness in a thickness direction perpendicular to the longitudinal direction or the width direction, and at least one second part having a second thickness greater than the first thickness, and
a portion of the second part providing a first dispersion area including at least a portion of the first side surface.

2. The battery of claim 1, wherein the circuit board assembly includes: an upper surface and a lower surface facing away from the upper surface, and
the first side surface connects at least a portion of an edge of the upper surface to at least a portion of an edge of the lower surface.

3. The battery of claim 1, wherein the circuit board assembly includes: an upper surface, a lower surface facing away from the upper surface, and a second side surface connecting a portion of an edge of the upper surface to a portion of an edge of the lower surface, and
the first side surface is disposed to face away from the second side surface and connects another portion of the edge of the upper surface to another portion of the edge of the lower surface.

4. The battery of claim 3, wherein the first side surface and the second side surface are parallel to each other.

5. The battery of claim 3, wherein the circuit board assembly further includes:
an arrangement space at least partially provided in the first part between the first side surface and the second side surface; and
at least one electric/electronic component disposed in the arrangement space, and
wherein the arrangement space is at least partially surrounded by the second part.

6. The battery of claim 5, wherein at least a portion of the arrangement space is exposed to an outside in a state of being in contact with the second part on the first side surface or the second side surface.

7. The battery of claim 3, wherein another portion of the second part forms a second dispersion area including at least a portion of the second side surface.

8. The battery of claim 7, wherein, when the second side surface is viewed through the first side surface, the first dispersion area and the second dispersion area at least partially overlap each other.

9. The battery of claim 1, wherein the circuit board assembly further includes:
a protective circuit board forming at least a portion of the first part and at least a portion of the second part; and
at least one reinforcing member mounted on at least one surface of the protective circuit board and forming the second part together with a portion of the protective circuit board.

10. The battery of claim 9, wherein the circuit board assembly further includes:
an arrangement space at least partially surrounded by the reinforcing member; and
at least one electric/electronic component disposed on the protective circuit board in the arrangement space.

11. The battery of claim 9, wherein at least a portion of the arrangement space is exposed to an outside on the first side surface.

12. The battery of claim 9, wherein the reinforcing member is disposed on each of opposite sides of the protective circuit board.

13. The battery of claim 9, wherein the circuit board assembly includes a bonding pad disposed on the protective circuit board, and
the reinforcing member is bonded to the protective circuit board via the bonding pad.

14. The battery of claim 9, wherein the first thickness is set to a thickness of the protective circuit board.

15. An electronic device comprising:
a housing;
a support disposed in the housing and including a partition protruding from one surface thereof; and
a battery at least partially seated on the one surface of the support in the housing,
wherein the battery includes:
a battery cell; and
a circuit board assembly including a charge protective circuit and disposed between the battery cell and the partition, and
wherein the circuit board assembly includes a first side surface disposed in a longitudinal direction or a width direction to face the battery cell, at least one first part having a first thickness in a thickness direction perpendicular to the longitudinal direction or the width direction, and at least one second part having a second thickness greater than the first thickness, and
a portion of the second part provides a dispersion area including at least a portion of the first side surface.

16. The electronic device of claim 15, wherein the circuit board assembly is disposed between the battery cell and the partition.

17. The electronic device of claim 15, wherein the circuit board assembly includes:
a protective circuit board forming at least a portion of the first part and at least a portion of the second part; and
at least one reinforcing member mounted on at least one surface of the protective circuit board and forming the second part together with a portion of the protective circuit board.

18. The electronic device of claim 17, wherein the support is at least partially arranged at a position adjacent to the reinforcing member in a direction facing the reinforcing member.

19. The electronic device of claim 17, wherein the circuit board assembly further includes a second side surface including another portion of the second part and facing away from the first side surface, and
the support is at least partially arranged at a position adjacent to the reinforcing member in a direction facing the second side surface.

20. The electronic device of claim 17, wherein the circuit board assembly further includes a bonding pad disposed on the protective circuit board, and
wherein the reinforcing member is bonded to the protective circuit board via the bonding pad.
